(19) United States
(12) Patent Application Publication
(10) Pub. No.: US 2016/0219834 A1
(43) Pub. Date: Aug. 4, 2016

(54) Protective Shield for an Animal

(71) Applicant: Orlando Cruz, Orlando, FL (US)

(72) Inventor: Orlando Cruz, Orlando, FL (US)

(21) Appl. No.: 14/608,274

(22) Filed: Jan. 29, 2015

(51) Int. Cl. A01K 13/00

(52) U.S. Cl. CPC A01K 13/006

(57) ABSTRACT

A novel protective shield to prevent an animal from licking or biting at wounds or stitches is disclosed. Unlike the common Elizabethan collar, the disclosed shield is open at the top to reduce stress and anxiety which may be caused by Elizabethan collars. Further, the shield is substantially in contact with the animal's ventral jaw so that it does not block the animal's range of sight. The lower profile of the shield also reduces the occurrence of the animal hitting the shield against an object but does not interfere with the use of the animal's collar. The shield is adjustable and may be easily removed by the animal's caretaker. The shield is sized to accommodate a range of dogs.

### FIELD OF THE INVENTION

The subject matter of this application relates to devices used to prevent an animal from reaching parts of its body with its mouth and tongue.

### BACKGROUND

Protective collars are often used in veterinary medicine to prevent an animal from reaching parts of its body with its mouth. Perhaps most commonly, the collars are used with dogs, although almost any animal can be so protected. For example, following an animal being spayed or neutered, a protective cover may be placed around its neck to prevent the animal from biting or licking the wound dressing or exposed sutures.

Often these collars are cut from a single piece of plastic a few millimeters thick and formed into the shape of cones around an animal's neck so that the narrow portion of the cone surrounds the animal's neck and the wider portion extends to the top of the animal's head or further. The body of the cone thereby forms a physical impediment to the animal reaching parts of its body. Once secured, the narrow portion of the cone, being more narrow than the animal's mandible, should prevent the animal from getting out of the collar. Due to the general appearance of the protective collar in use, they are often called “Elizabethan collars.”

These collars are most often made from a sheet of somewhat flexible plastic; and, since the basic design can be manufactured at a comparatively low cost, there are several manufacturers in the market. Even so, the art describes variations on the general theme of Elizabethan collars. For example, U.S. Pat. No. 5,012,764 discloses adjustable collars that can be reapplied after removal. U.S. Pat. No. 5,197,414 discloses a variation wherein the collar is designed to allow water to freely flow out of it so that although an animal's head is blocked, it can still be safely washed. USD632851 is another example of a patent claiming a design of an Elizabethan collar.

Other patents have disclosed other styles of Elizabethan collars using materials and methods that are less likely to irritate the animal where the collar touches its neck. For example, U.S. Pat. No. 6,659,046 discloses an inflatable collar with an optional foam layer that can be placed on an animal without having to slide the collar over the animal's neck. U.S. Pat. No. 4,476,814 discloses a collar comprising a solid foam and an adjustable closing means. A recovery collar is disclosed in U.S. Pat. No. 6,044,802 that comprises a doughnut shaped pillow held in place by a drawstring laced through a shawl that extends into the center hole of the pillow. U.S. Pat. No. 8,042,494 discloses an Elizabethan collar, similar in some respects to the subject matter of U.S. Pat. No. 5,012,764, but that comprises sheets of a flexile material and a sheet of a resilient material so that the resulting collar resists deformation, but also yields to reduce irritation to the animal's neck region.

Elizabethan collars formed of ridged plastic may irritate an animals neck, but they are effective and comparatively simple and lower-priced than the other options that are formed out of softer materials. Unfortunately, using softer, less irritating materials may lessen the effectiveness of the collar and permit the animal to reach parts of its body with it's tongue and teeth. This issue has been addressed in U.S. Pat. No. 8,739,741.

The cone design of the Elizabethan collar prevents more than just the licking or biting behavior it is meant to restrict. Because of their size, these collars also can block a portion of the animal's visual field and may interfere with other behaviors such as eating or drinking. They can also make it uncomfortable for the animal to rest its head normally, both for the animal itself, and for its caretaker who may find the the collar pressed into his lap while petting the animal.

### SUMMARY

The subject matter of this application pertains to protective shields that restrict an animal's ability to bite or lick at wounds or exposed sutures. More specifically, the subject matter of this application pertains to a low profile guard that covers an animal's ventral jaw and extends beyond the animal's nose to prevent the animal from biting or licking at wounds or exposed sutures, without blocking the animal's vision and without substantially interfering with the animals' ability to eat or drink normally. Further, the guard is easily adjustable and customizable to the animal's head.

### BRIEF DESCRIPTION OF THE DRAWINGS

FIG. 1 is a view of a the guard in place on a dog.

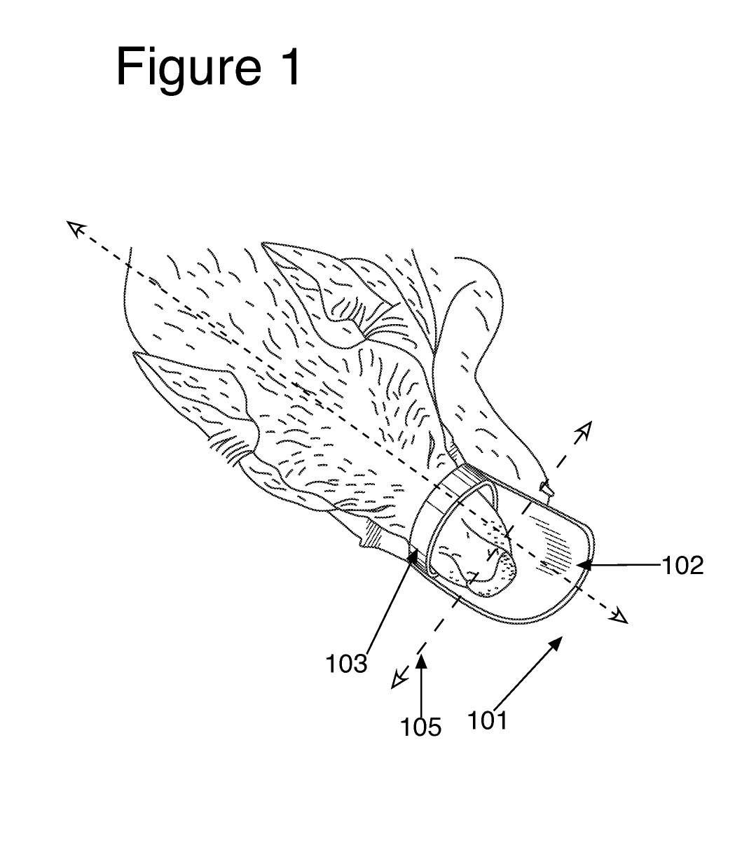

FIG. 2 is another view of the guard in place on a dog.

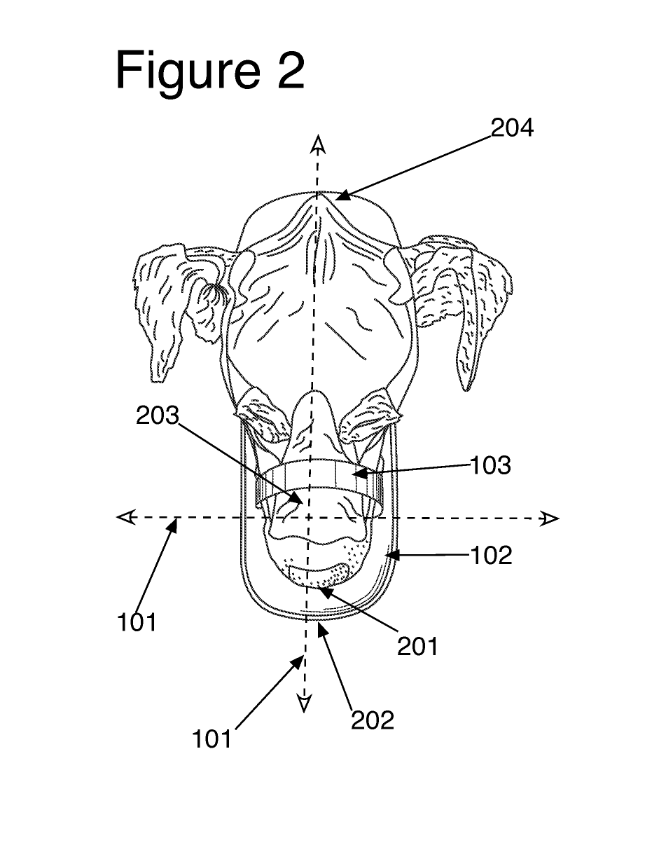

FIG. 3 is a view of the bottom side of the guard.

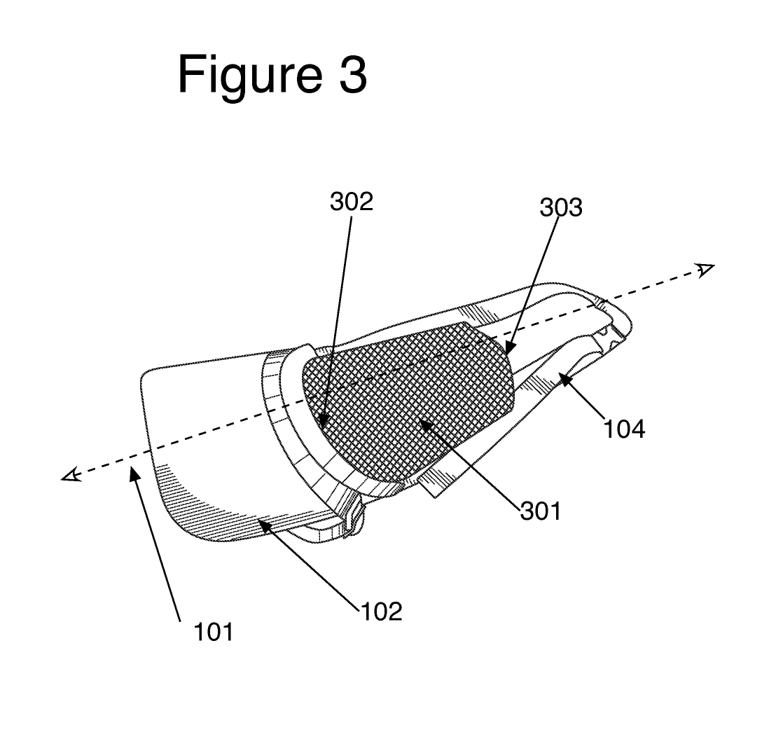

FIG. 4 is a view of the top side of the guard.

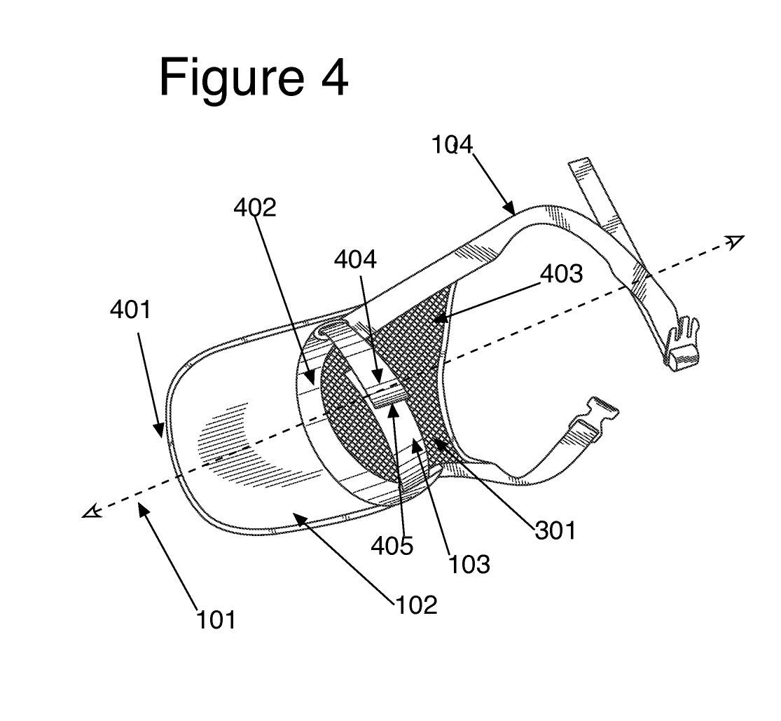

### DETAILED DESCRIPTION OF THE DRAWINGS

The following descriptions and drawings referenced therein illustrate embodiments of the applications subject matter. They are not intended to limit the scope. Those familiar with analogous arts may recognize that other embodiments of the subject matter are possible. All such alternative embodiments should be considered within the scope of the application's claims.

Each reference number consists of three digits. The first digit corresponds to the figure number in which that reference number is first used. Reference numbers are not necessarily discussed in the order of their appearance in the figures.

The subject matter of this application concerns a minimally intrusive protective guard that prevents an animal from biting or licking at wounds or exposed sutures. The guard is adjustable and customizable to accommodate a wide range of animals. The minimalistic structure of the guard reduces the stress which may be associated with the currently standard Elizabethan collar.

The drawings and much of the specification refer to dogs. This is to most efficiently describe the subject matter of this application and should not be construed to limit the subject matter of this application to its use with dogs. Further, the drawings illustrate a dog having an elongated snout, however this should not be construed to limit the subject matter of this application to just such long-snouted dogs. Rather, minor modifications, well within the skill of anyone familiar with the relevant arts, that might be necessary to permit the subject matter of this application to be used with other head shapes and sizes, should be interpreted to be within the scope of the disclosure and claims.

This application discloses a novel design for a protective shield such as an animal would wear to prevent the animal from licking or biting at wounds or sutures. The disclosed collar has a lower profile than Elizabethan (cone) collars well-known in the art, which allows for a greater range of vision than cone collars. The size and shape of the shield also reduces the possibility of the protective collar hitting, or getting stuck on an object while worn, and lessens the difficulties in eating and drinking often associated with cone collars.

In the preferred embodiment, the protective shield comprises a longitudinal axis (101), parallel to the longitudinal axis of a dog's head when the protective shield is temporarily attached to the dog's head.

The protective shield further comprises a guard (102), a support (301), a first attachment means (103), a second attachment means (104) a first lateral side, and a second lateral side.

The guard is a semi-flexible so that it largely retains its shape, but can be bent to partially conform to the animal's ventral snout and comprises a longitudinal axis (101), a transverse axis (105) a first lateral side (304) and a second lateral side (305). A section of the guard along its transverse axis shows substantially a semi-circle such that the guard roughly conforms to the shape of the dog's ventral jaw when in use. The guard has a rostral (401) and a caudal (402) side. Said rostral side terminates beyond the tip of the dog's snout to restrict the dog's licking and biting range. The distance between the tip of the dog's snout (201) and the guard's rostral terminus (202) may be as little as a millimeter, although in preferred embodiments, the said distance is at least 2.5 centimeters. The maximum distance is preferably no more than 10 centimeters, although certain dogs with very long tongues may need a longer guard to be effective. The guard may further comprise a soft outer coating to reduce irritation to the dog. In a preferred embodiment, the guard is partially constructed with plastic such as that commonly used in baseball hat brims which has the desired semi-flexible qualities. Preferably, such plastic is at least partially covered by a softer material such as cloth to a foam to minimize irritation to the animal. In a most highly preferred embodiment, the guard can be cut with common household scissors to customize the length so that it extends past the animal's snout no more than necessary to inhibit self biting and licking behaviors.

The support is also aligned with the collar's longitudinal axis (101), and comprises a rostral end (302), and a caudal end (303). The caudal side of the guard is continuous with, or connected to, the rostral end of the support. The support is comprised of a flexible material such as a fabric or mesh. In preferred embodiments, the supports further comprises a plurality of channels or holes (403), to allow air or liquid to pass through the support when in use.

The guard further comprises a first attachment means (103) that reversibly secures the guard to the dog's snout (203). In a preferred embodiment, the first attachment means comprises a strap attached to one of the guard's lateral sides, said strap comprising one half of a hook and loop type fastener (404) which can attach to a the other half of a hook and loop type fastener (405) located on, or attached to, the guard's other lateral side. In a most preferred embodiment, each of the guard's lateral sides may comprise a strap, and that each of these said straps may comprise one half of a hook and loop type fastener, such that the straps may be reversibly attached to each other. When the first attachment means in engaged, a transverse view of the protective collar at the level of the attachment mean shows an annular structure, such that the guard could be slid on or off the dog's snout. An alternate embodiment uses side release buckles instead of hook and loop type fasteners. Other attachment means are well known in the art and should be considered to fall within this application's disclosure and claims.

The protective collar further comprises a second attachment means (104) that reversibly secures the protective collar the back of the dog's head (204). In a preferred embodiment, the second attachment means comprises a strap attached to one of the protective collar's lateral sides, said strap comprising one half of a side release buckle which can attach the other half of said side release buckle located on the protective collar's other lateral side. In a most preferred embodiment, each of the protective collar's lateral sides may comprise a strap, and that each of these said straps may comprise one half of a side release buckle, such that the straps may be reversibly attached to each other. As with the first attachment means, hook and loop type fasteners, or other such fasteners known in the art, may be used and should be considered within the scope of this disclosure and claims.

Further, any strap that comprises part of an attachment means may also comprise adjustment means for lengthening or shortening the length of the strap.

Accordingly, I claim:

1. A protective shield comprising a longitudinal axis, a transverse axis, a first lateral side, a second lateral side, a rostral terminus, a caudal terminus, guard, a support, a first attachment means and a second attachment means,
a. said guard extending from the protective shield's rostral terminus towards the protective shield's caudal terminus along the collar's longitudinal axis, the guard further
i. comprising a semi-flexible material,
b. said support being continuous with the guard and extending to the shield's caudal terminus
c. said first attachment means comprising at least one strap attached to the protective shield's first lateral side and capable of being reversibly attached to the the protective shield's second lateral slide such that the protective shield may be reversibly secured around the animals' snout, and
d. said second attachment means comprising at least one strap attached to the protective shield's first lateral side and capable of being reversibly attached to the the protective shield's second lateral slide such that the protective shield may be secured around the base of an animal's skull.
